(19) United States
(12) Patent Application Publication
(10) Pub. No.: US 2005/0289534 A1
(43) Pub. Date: Dec. 29, 2005

(54) Method for upgrading software version of mobile terminal using integrated difference files

(75) Inventors: Suk-Soon Kim, Suwon-si (KR); Kwon Yeo, Seoul (KR); Sang-Bong Lee, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/081,179

(22) Filed: Mar. 16, 2005

(30) Foreign Application Priority Data
Jun. 24, 2004 (KR) 10-2004-0047739

(51) Int. Cl. G06F 9/44

(52) U.S. Cl. 717/172

(57) ABSTRACT

A method for upgrading a software version of a UE (User Equipment) using integrated difference files. The software upgrade method for upgrading a software version of the UE includes the steps of generating, by a service provider, difference files between a plurality of software versions and an integrated difference file of the difference files; transmitting, by the service provider, the integrated difference file to the UE via a mobile communication enterprise; and upgrading, by the UE, the software program stored in the UE to a selected target software version with reference to the integrated difference file.

### PRIORITY

This application claims priority to an application entitled “METHOD FOR UPGRADING SOFTWARE VERSION OF MOBILE TERMINAL USING INTEGRATED DIFFERENCE FILES”, filed in the Korean Intellectual Property Office on Jun. 24, 2004 and assigned Serial No. 2004-47739, the contents of which are hereby incorporated by reference.

### BACKGROUND OF THE INVENTION

1. Field of the Invention

The present invention relates to a mobile terminal, and more particularly to a method for upgrading a software version of a mobile terminal.

2. Description of the Related Art

Typically, a mobile terminal includes a transceiver, a data I/O (Input/Output) unit, and an antenna so as to establish transmission/reception of audio and/or video data signals with a counterpart terminal.

The mobile terminal includes a software program for controlling/utilizing predetermined hardware functions. The software program is stored in a nonvolatile memory such as a flash memory installed in the mobile terminal. An initial software program is stored in the mobile terminal during a production. Eventually, with the progression of time, newer versions of this program are released and the older versions become outdated. When the newer versions of the program are installed in mobile terminals, terminals which are either older or not updated with the newest version of the software program maybe unable to receive the newest or the latest mobile services from a mobile communication enterprise.

Conventionally, in order to upgrade a software version of such a mobile terminal, a user must visit an after-sale service (A/S) center of a production company of the mobile terminal, or must use an additional terminal software upgrade device such as a software upgrade system. However, the aforementioned software upgrade method for use in the conventional terminal is not passive and therefore is inconvenient, and has a disadvantage in that the user must remember to constantly upgrade the software version so as to be able to receive the newest and/or the latest mobile services from a mobile communication system.

When a user gains access to a mobile communication service provider so as to receive a corresponding service using a mobile terminal (hereinafter referred to as a User Equipment (UE)), there is needed a method for enabling the service provider to provide the UE with a difference software program (i.e., update software) when update software becomes available.

FIG. 1 is a flow diagram illustrating a method for upgrading a software program stored in the conventional mobile terminal.

Upon receiving a command for executing a corresponding service from a user, the UE 30 transmits a service access request signal to the mobile communication enterprise 20 at step S10. The mobile communication enterprise 20 transmits a service authentication request signal to the service provider 10 in order to determine whether the UE 30 is an authenticated UE for the corresponding service at step S12. In this case, the service provider 10 may be indicative of a server managed by a production company of the UE 30 or a server managed by a specific enterprise for providing a user with the service using the UE 30.

The service provider 10 confirms authentication of the UE 30, and confirms a version of a software program stored in the UE 30. Upon receipt of the confirmed results, the service provider 10 determines whether a more recent software program than the old software program stored in the UE 30 is found at step S16. If it is determined that there is no new software program at step S16, the service provider 10 and the UE 30 perform a corresponding service using the mobile communication enterprise 20 at steps S36a and S36b.

If a new software program is found at step S16, the service provider 10 transmits a specific signal indicating whether the software program is to be upgraded to a new software version to the UE 30 at steps S18 and S20 via the mobile communication enterprise 20. The UE 30 determines whether the specific signal indicative of the presence or absence of an upgrade operation is received at step S22. If it is determined that a signal indicative of no upgrade operation is received, the UE 30 and the service provider 10 execute a corresponding service at steps S36a and S36b using the mobile communication enterprise 20.

The service provider 10 previously generates one or more difference file(s) (i.e., a file which contains the difference software program) whenever a production company develops a new version, and registers the generated difference file in a service managed by the service provider 10. Upon receipt of a software upgrade command, the UE 30 transmits an upgrade request signal to the service provider 10 via the mobile communication enterprise 20 at steps S24 and S26. Upon receiving an upgrade request signal from the UE 30, the service provider 10 generates one or more difference files which are between the old software version stored in the UE 30 and a new software version associated with the upgrade request signal at step S28.

The service provider 10 transmits the difference file(s) to the UE 30 via the mobile communication enterprise 20 at steps S30 and S32. The UE 30 upgrades its pre-stored software version on the basis of the one or more difference files received from the service provider 10 at step S34. If the old software version is upgraded to the new software version at step S34, the UE 30 and the service provider 10 perform a corresponding service at steps S36a and S36b using the mobile communication enterprise 20. However, the aforementioned software upgrade method of the UE has a disadvantage in that the software upgrade operation must be repeatedly performed whenever the software program version of the UE is older than the other software program version that the service provider 10 currently uses.

If a user desires to upgrade their software program version from a version 1.0 to a version 2.0, the aforementioned software upgrade method has another disadvantage in that the upgrade operation must be repeatedly performed for every step (e.g., version 1.2, version 1.5, version 1.7, . . . , version 2.0) until upgrading the software version between the service provider 10 and the UE 30 from version 1.0 to version 2.0, resulting in a longer period of time being consumed for the upgrade operation.

Although FIG. 1 exemplarily depicts steps S10 and S12 in which the UE requests a service access, it should be noted that the example is available for a specific case in which the service provider 10 is equal to a server of a game service provider. For example, if the user desires to upgrade the old software version to the new software version, the service provider 10 may firstly generate a software version difference file without using the step S10 performed by the UE 30, such that the software version difference file may be directly transmitted to the UE 30.

As another example, if the service provider 10 is equal to a production company of the UE 30, such a software version difference file is generated before steps S22, S24, and S26 for requesting the software version upgrade operation are preformed using the UE 30, such that it may be transmitted to the mobile communication enterprise 20.

However, the aforementioned examples also have the same problems as those of the conventional software version upgrade method of FIG. 1.

### SUMMARY OF THE INVENTION

Therefore, the present invention has been made in view of the above problems, and it is an object of the present invention to provide a method for simply upgrading a software version of a UE, irrespective of version information of a software program.

It is another object of the present invention to provide a UE software upgrade method for reducing a time consumed for upgrading an old software version to a new software version of the UE, and receiving all update information necessary for a user-desired software version only once such that it can upgrade the old software version to the user-desired software version in a single operation.

In accordance with one aspect of the present invention, the above and other objects can be accomplished by the provision of a method for upgrading a software version of a UE in a communication system including the UE for storing a software program executing a corresponding service; a service provider for providing the UE with the service and a software version needed for the service; and a mobile communication enterprise for providing the service provider and the UE with a communication service for the service, including the steps of generating, by the service provider, difference files between a plurality of software versions and an integrated difference file of the difference files; transmitting the integrated difference file to the UE via the mobile communication enterprise; and upgrading, by the UE, the software program stored in the UE to a selected target software version with reference to the integrated difference file.

Preferably, the service provider includes first and second storage units each for storing the same software versions needed for the service; a difference file generator for comparing individual software versions stored in the first and second storage units, and generating difference files among individual software versions; and an integrated difference file generator for integrating the difference files generated in one file, and generating the integrated difference file. It should be noted that the first and second storage units can be physically integrated into only one storage unit.

Preferably, the upgrade step includes the steps of dividing the integrated difference file into difference files of individual software versions; checking a software version stored in the UE, and determining whether a target software version for a software upgrade operation is selected; and upgrading the checked software version to the selected target software version by referring to the difference files of individual software versions.

Preferably, the method further includes the step of, transmitting storage capacity and upgrade time information of the UE, required for upgrading the software version to the target software version, to a user via a user interface, if the target software version is selected.

In accordance with another aspect of the present invention, there is provided a method for upgrading a software version of a UE including the steps of transmitting, by the service provider, an integrated difference file to a mobile communication enterprise irrespective of the presence or absence of a service access request; storing, by the mobile communication enterprise, the integrated difference file transmitted from the service provider; and transmitting, by the mobile communication enterprise, the stored integrated difference file to the UE upon receipt of the service access request.

In accordance with yet another aspect of the present invention, there is provided a method for upgrading a software version of a UE in a communication system including the UE for storing a software program executing a corresponding service; a service provider for providing the UE with the service and a software version needed for the service; and a mobile communication enterprise for providing the service provider and the UE with a communication service for the service, including the steps of transmitting a service access request to the service provider via the mobile communication enterprise in order to receive the service; receiving an integrated difference file in which difference files between a plurality of software versions of the service provider are integrated; upgrading, by the UE, the software program stored in the UE for the service to a selected target software version with reference to the integrated difference file.

Preferably, the upgrade step includes the steps of dividing the integrated difference file into difference files of individual software versions; checking a software version stored in the UE, and determining whether a target software version for a software upgrade operation is selected; and upgrading the checked software version to the selected target software version by referring to the difference files of individual software versions.

Preferably, the method includes the step of if the target software version is selected, transmitting storage capacity and upgrade time information of the UE, required for upgrading the software version to the target software version, to a user via a user interface.

The present invention detects a difference file between software versions, generates an integrated difference file corresponding to the detected difference file, transmits the integrated difference file to the UE, and upgrades an old software version to a new software version selected by the UE on the basis of the integrated difference file, such that it can more simply upgrade a software version to a desired software version. Furthermore, if the software version is upgraded to a target software version requiring a plurality of steps, the software version is upgraded to the target software version with reference to difference files of individual versions of the integrated difference file of all the software versions providable from the service provider, such that a software version of the UE can be simply upgraded to the target software version irrespective of software version information, and a time consumed for the upgrade operation and the number of access times between the UE and the service provider can be reduced.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram chart illustrating a conventional method for upgrading a software version of a UE;

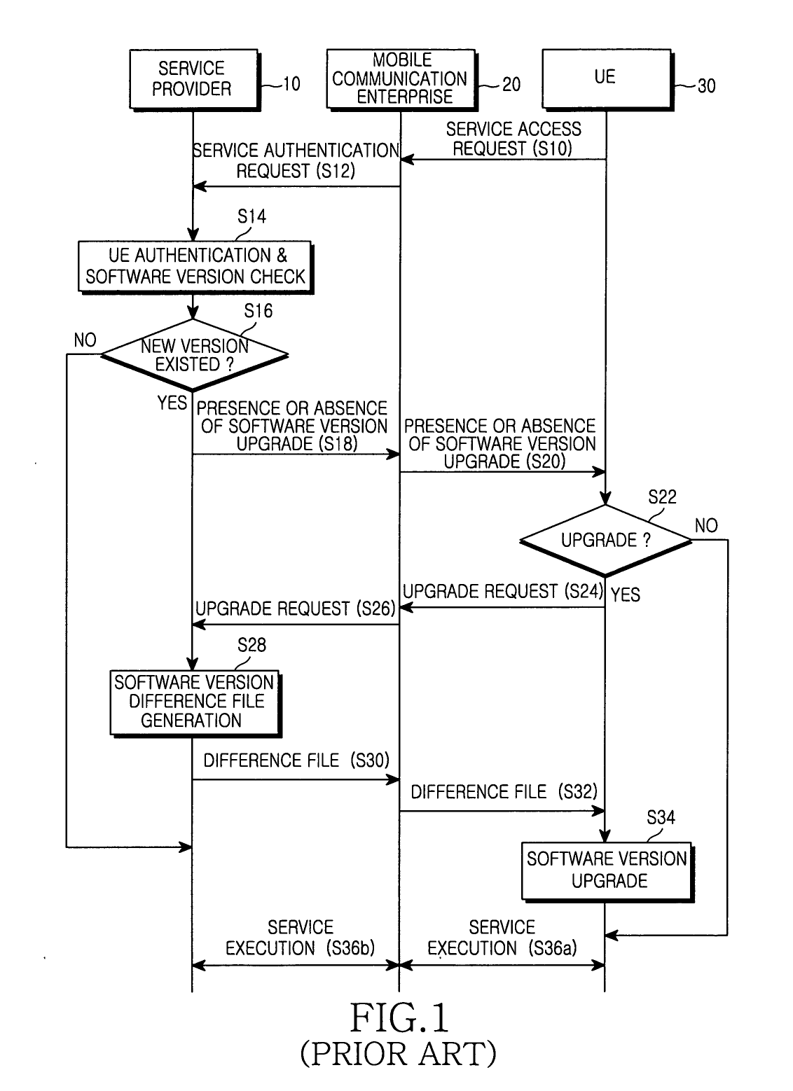

FIG. 2 is a flow diagram illustrating a method for simply upgrading a software version of a UE in accordance with a preferred embodiment of the present invention;

FIG. 3 is a diagram illustrating components needed for the service provider of FIG. 2 when the service provider generates an integrated difference file in accordance with a preferred embodiment of the present invention;

FIG. 4 is a diagram illustrating an exemplary integrated difference file generated from an integrated difference file generator of FIG. 3 in accordance with a preferred embodiment of the present invention; and

FIG. 5 is a flow chart illustrating a method for controlling the UE to upgrade an old software version to a new software version selected by an integrated difference file in accordance with a preferred embodiment of the present invention.

### DETAILED DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention unclear.

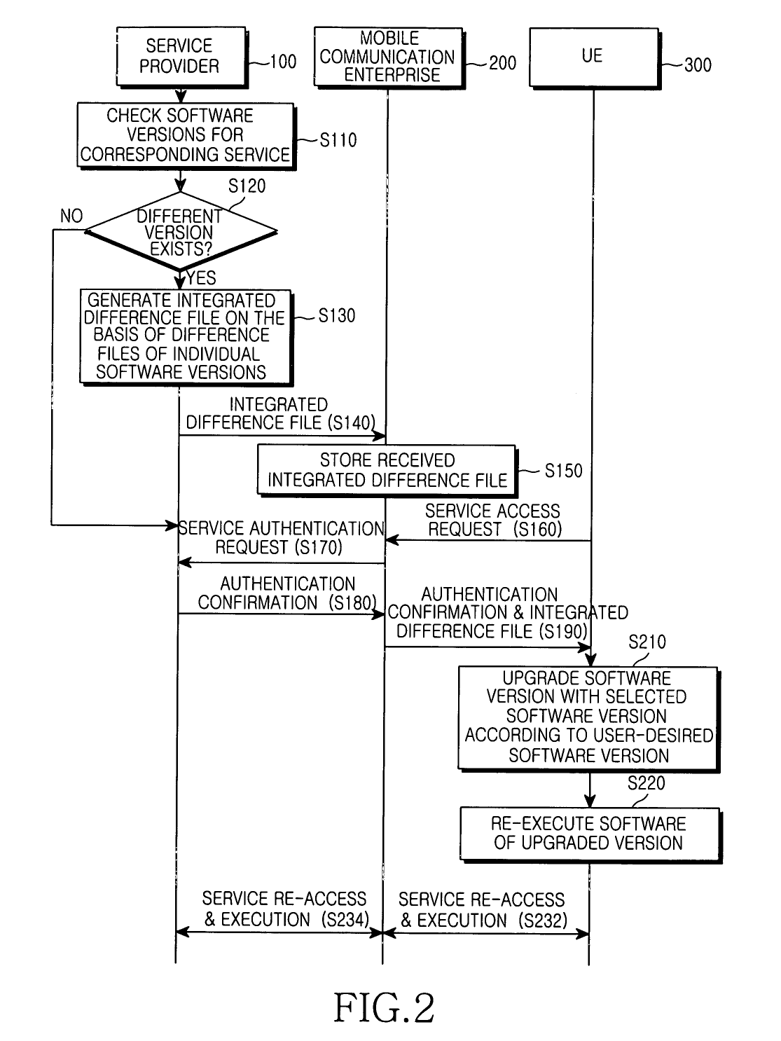

FIG. 2 is a flow diagram illustrating a method for upgrading a software version of a UE according to a preferred embodiment of the present invention.

The service provider 100 determines version information of its own software program needed for providing the UE 300 with a corresponding service at step S110. In this case, the service provider 100 determines whether there is/are different software version(s) of a software program needed for the service at step S120. If it is determined that there is are/no different software version(s) in the software program needed for the service at step S120, steps from S160 to S234 are performed.

If it is determined that there is/are different software version(s) of the software program needed for the service at step S120, the service provider 100 generates difference files of individual software version(s), and generates an integrated difference file, in which the difference file(s) is/are integrated, on the basis of the difference files of the software versions at step S130. In this case, the service provider 100 transmits the integrated difference file to the mobile communication enterprise 200 at step S140.

The mobile communication enterprise 200 receives the integrated difference file from the service provider 100, and stores the received integrated difference file in a predetermined DB (DataBase) at step S150.

In the meantime, if the UE 300 receives a service execution command from the user to receive a corresponding service, it transmits a service access request signal for executing the service to the mobile communication enterprise 200 at step S160. Upon receiving the service access request signal from the UE 300, the mobile communication enterprise 200 transmits a service authentication request signal to the service provider 100 such that the service provider can determine whether the UE 300 is authenticated for the service at step S1170.

The service provider 100 determines whether a service of the UE 300 is authenticated upon receiving an authentication request from the mobile communication enterprise 200, and transmits an authentication determination signal to the mobile communication enterprise 200 at step S180. Upon receiving the authentication determination signal from the service provider 100, the mobile communication enterprise 200 transmits the integrated difference file having been received at the above step S140 from the service provider 100 to the UE 300 at step S190.

Upon receipt of the authentication determination signal and the integrated difference file, the UE 300 upgrades a software version to a specific software version selected on the basis of the integrated difference file according to a desired upgrade software version selected by the user from among a plurality of software versions at step S210. If the software version is completely upgraded to the user-selected software version, the UE 300 executes a corresponding software program using the newly-upgraded software version at step S220. This execution of the new software program causes the service provider 100 and the UE 300 to perform a re-access operation for executing the service using the mobile communication enterprise 200, and execute the service at steps S232 and S234.

Therefore, it is seen that the service provider 100 detects difference files between software versions, generates an integrated difference file corresponding to the detected difference files, transmits the integrated difference file, and upgrades a software version to a new software version selected by the UE 300 on the basis of the integrated difference file, such that it can simply upgrade a target software version to a desired software version.

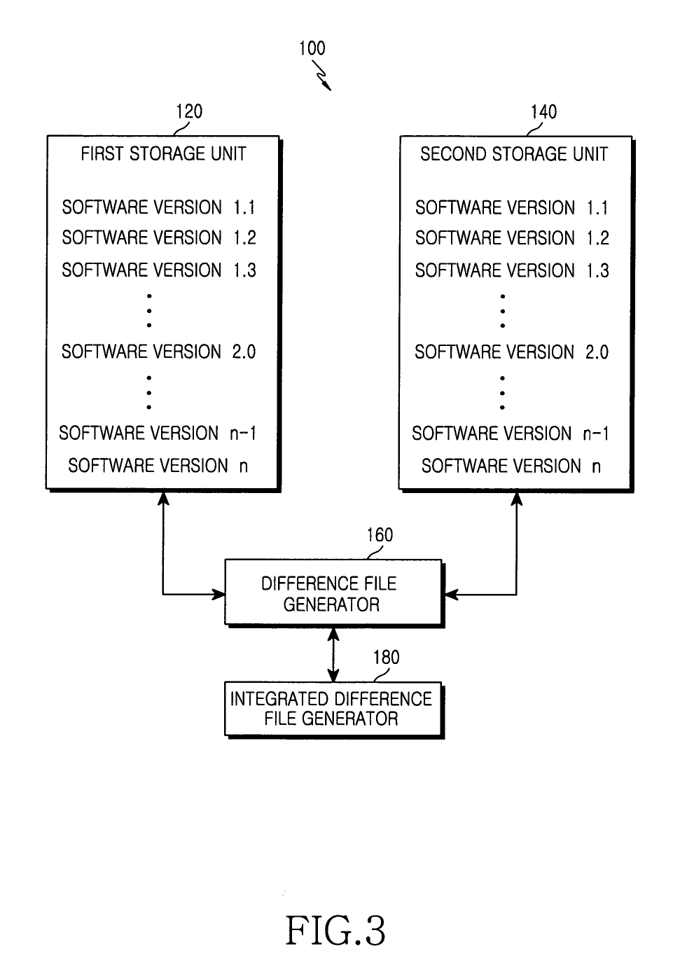

FIG. 3 is a diagram illustrating components needed for the service provider 100 of FIG. 2 when the service provider generates the integrated difference file in accordance with an embodiment of the present invention.

Referring to FIG. 3, the service provider 100 includes first and second storage units 120 and 140, a difference file generator 160, and an integrated difference file generator 180 such that it can generate the integrated difference file.

The first and second storage units 120 and 140 store the same software versions, respectively. In more detail, each of the first and second storage units 120 and 140 store software programs of 1.1, 1.2, . . . , n-1, and n versions.

The difference file generator 160 generates difference files between individual software versions stored in the first and second storage units 120 and 140, respectively. The integrated difference file generator 180 integrates the individual difference files generated from the difference file generator 160 into one file, such that it generates a single integrated difference file.

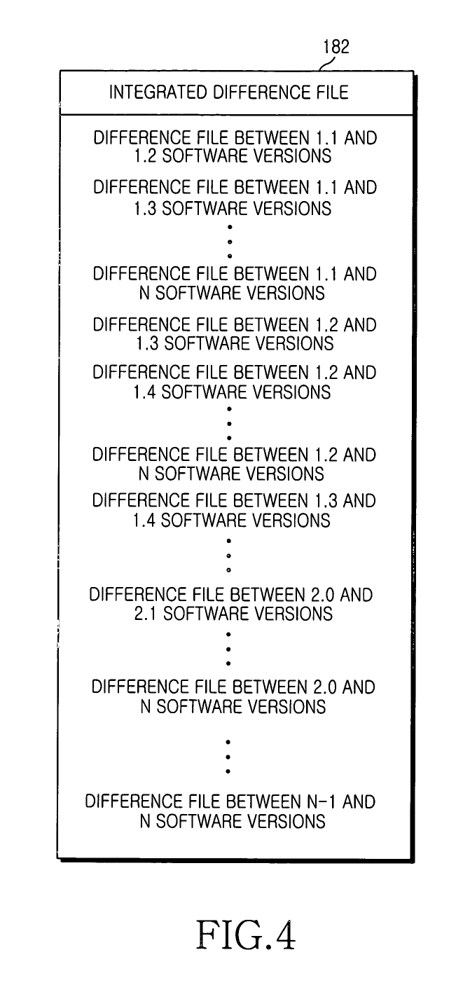

FIG. 4 is a diagram illustrating an exemplary integrated difference file generated from the integrated difference file generator 180 of FIG. 3 in accordance with a preferred embodiment of the present invention.

Referring to FIG. 4, the integrated difference file 182 includes a variety of software versions from version 1.1 to n. Therefore, there are a variety of integrated difference files from a difference file between the 1.1 and 1.2 software versions as shown to the last difference file between n-1 and n software versions, as shown.

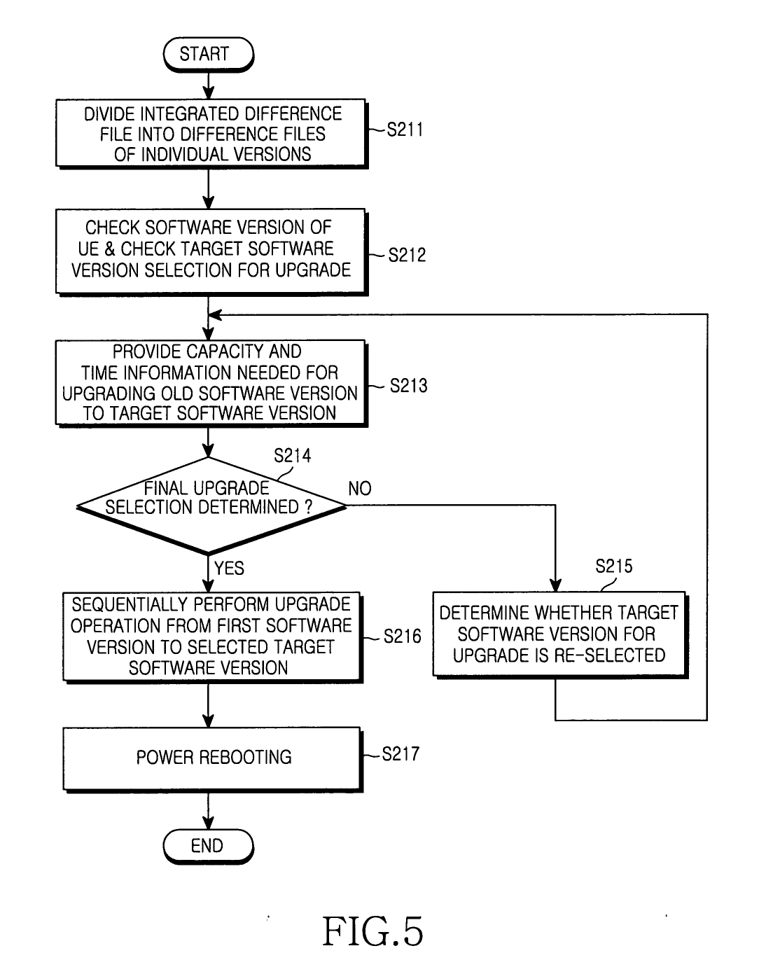

FIG. 5 is a flow chart illustrating a method for controlling the UE 300 to upgrade an old software version to a new software version selected by an integrated difference file.

Referring to FIG. 5, upon receipt of the integrated difference file, the UE classifies the integrated difference file according to individual software versions at step S211. The UE 300 checks its old software version, and checks that a target software version for a software upgrade operation is selected at step S212.

When the target software version for the software upgrade operation is selected at step 212, the UE 300 provides capacity and time information required for upgrading the old software version to the target software version to the UE via a user interface such as an LCD (Liquid Crystal Display), or speaker (as other suitable notification means) at step S213.

The UE 300 checks the capacity and time information needed for upgrading the old software version to the target software version, and determines whether a user enters the final selection command for the software upgrade operation at step S214. If it is determined that the user does not enter the final selection command for the software upgrade operation at step 214, the UE determines whether the target software version for the software upgrade operation is re-selected at step S215, and returns to step S213 such that it re-performs steps S213 and S214.

Upon receipt of the last selection command for the software upgrade operation at step S214, the UE 300 sequentially upgrades a software version from a previous software version to the finally-selected target software version according to difference files of individual software versions generated by separation of the integrated difference file at step S216.

If the software version is upgraded to the target software version with reference to the difference files for each version, the UE 300 performs a power-supply rebooting process at step S217.

Therefore, if the software version is upgraded to a target software version requiring a plurality of steps, the software version is upgraded to the target software version with reference to difference files of individual versions of the integrated difference file of all the software versions providable from the service provider 100, such that a software version of the UE can be simply upgraded to the target software version irrespective of software version information, and the time consumed for the upgrade operation and the number of access times between the UE and the service provider can be reduced.

As apparent from the above description, the present invention detects a difference file between software versions, generates an integrated difference file corresponding to the detected difference file, transmits the integrated difference file to the UE, and upgrades an old software version to a new software version selected by the UE on the basis of the integrated difference file, such that it can more simply upgrade a software version to a desired software version.

Furthermore, if the software version is upgraded to a target software version requiring a plurality of steps, the software version is upgraded to the target software version with reference to difference files of individual versions of the integrated difference file of all the software versions providable from the service provider, such that a software version of the UE can be simply upgraded to the target software version irrespective of software version information, and a time consumed for the upgrade operation and the number of access times between the UE and the service provider can be reduced.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method for upgrading a software version of a UE (User Equipment) in a communication system including the UE for storing a software program executing a corresponding service; a service provider for providing the UE with the service and a software version needed for the service; and a mobile communication enterprise for providing the service provider and the UE with a communication service for the service, comprising the steps of:
a) generating, by the service provider, one or more difference files between a plurality of software versions and an integrated difference file containing the one or more difference files;
b) transmitting the integrated difference file to the UE via the mobile communication enterprise; and
c) upgrading, by the UE, the software program stored in the UE to a selected target software version with reference to the integrated difference file.

2. The method according to claim 1, wherein the service provider includes:
first and second storage units each for storing the same software versions needed for the service;
a difference file generator for comparing individual software versions stored in the first and second storage units, and generating difference files among individual software versions; and
an integrated difference file generator for generating the integrated difference file, which contains the one or more difference files.

3. The method according to claim 1, wherein step (c) includes the steps of:
c1) dividing the integrated difference file into the one or more difference file(s);
c2) checking a software version stored in the UE, and determining whether a target software version for a software upgrade operation is selected; and
c3) upgrading the checked software version to the selected target software version by referring to the one or more difference files.

4. The method according to claim 3, further comprising the step of:
if the target software version is selected, transmitting storage capacity and upgrade time information of the UE, which is required for upgrading the software version to the target software version to a user via a user interface.

5. The method according to claim 1, further comprising the steps of:
d) upon receiving a service access request from the UE, transmitting, by the service provider, the integrated difference file to the mobile communication enterprise;
e) storing, by the mobile communication enterprise, the integrated difference file transmitted from the service provider; and
f) upon receipt of the service access request from the UE, transmitting, by the mobile communication enterprise, the stored integrated difference file to the UE.

6. A method for upgrading a software version of a UE (User Equipment) in a communication system including the UE for storing a software program executing a corresponding service; a service provider for providing the UE with the service and a software version needed for the service; and a mobile communication enterprise for providing the service provider and the UE with a communication service for the service, comprising the steps of:
a) transmitting a service access request to the service provider via the mobile communication enterprise;
b) receiving an integrated difference file in which difference files between a plurality of software versions are integrated;
c) upgrading, by the UE, a software program stored in the UE for the service to a selected target software version with reference to the integrated difference file.

7. The method according to claim 6, wherein step (c) includes the steps of:
c1) dividing the integrated difference file into one or more difference files;
c2) checking the software version stored in the UE, and determining whether the target software version for a software upgrade operation is selected; and
c3) upgrading the checked software version to the selected target software version by referring to the one or more difference files.

8. The method according to claim 7, further comprising the step of:
if the target software version is selected, transmitting storage capacity and upgrade time information of the UE, which is required for upgrading the software version to the target software version, to a user via a user interface.
